(19) United States
(12) Patent Application Publication
(10) Pub. No.: US 2024/0098694 A1
(43) Pub. Date: Mar. 21, 2024

(54) PAGING OCCASION UPDATE USING A REGISTRATION REQUEST

(71) Applicant: QUALCOMM Incorporated, San Diego, CA (US)

(72) Inventors: Ling XIE, Beijing (CN); Liang HONG, Beijing (CN); Cheol Hee PARK, San Diego, CA (US); Qingxin CHEN, San Diego, CA (US); Jun HU, San Diego, CA (US); Rishav REJ, San Diego, CA (US); Reza SHAHIDI, La Jolla, CA (US); Zhenyu LIU, Beijing (CN); Xiaoyu LI, Beijing (CN)

(21) Appl. No.: 18/264,401

(22) PCT Filed: Mar. 8, 2021
(86) PCT No.: PCT/CN2021/079480

§ 371 Date: Aug. 4, 2023

(51) Int. Cl. H04W 68/02; H04W 8/20; H04W 56/00; H04W 60/04

(52) U.S. Cl. CPC H04W 68/02; H04W 8/20; H04W 56/0015; H04W 60/04

(57) ABSTRACT

Methods, systems, and devices for wireless communications are described. A user equipment (UE) may establish one or more wireless connections for different subscriptions with a base station. The UE may receive an indication of a temporary mobile subscription identifier (TMSI) from the base station during a registration procedure. The UE may calculate a paging occasion (PO) based on the TMSI and may determine the PO fails to satisfy a threshold timing value. The UE may transmit one or more registration request to trigger additional registration procedures in which base station may transmit a new TMSI. The UE may calculate an updated PO based on the new TMSI. The UE may periodically receive one or more paging messages from the base station in a set of POs based on calculating the updated PO.

### CROSS REFERENCE

The present application is a 371 national stage filing of International PCT Application No. PCT/CN2021/079480 by XIE et al. entitled “PAGING OCCASION UPDATE USING A REGISTRATION REQUEST,” filed Mar. 8, 2021, which is assigned to the assignee hereof, and which is expressly incorporated by reference in its entirety herein.

### FIELD OF TECHNOLOGY

The present disclosure relates to wireless communications, including paging occasion (PO) update using a registration request.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support paging occasion update using a registration request. Generally, the described techniques provide for a user equipment (UE) to transmit one or more registration request if a paging occasion (PO) fails to satisfy a threshold timing value (e.g., is too close to a PO for another subscription, is too far away from a synchronization signal block (SSB) window, or both). A base station may transmit a new temporary mobile subscription identifier (TMSI) in response to the registration request, and the UE may use the new TMSI to calculate an updated PO. The updated PO may satisfy the threshold timing value by resolving timing conflicts for multiple subscriptions or may satisfy the threshold timing value by moving the PO in which the UE monitors for paging messages closer to the SSB window. In some cases, the UE may continue to transmit additional registration requests until a PO satisfies the threshold timing value for either an SSB window, a PO for another subscription, or both or until reaching a limit for total number of registration requests.

A method for wireless communications at a UE is described. The method may include establishing a first wireless connection with a base station, receiving an indication of a first TMSI for the UE, the first TMSI corresponding to a first set of POs for the UE that fail to satisfy a threshold timing value for the UE, transmitting, to the base station, a registration request at least in part in response to receiving the indication of the first TMSI, receiving a response to the registration request that indicates a second TMSI for the UE, and receiving one or more paging messages from the base station in a second set of POs that correspond to the second TMSI.

An apparatus for wireless communications at a UE is described. The apparatus may include a processor, memory coupled with the processor, and instructions stored in the memory. The instructions may be executable by the processor to cause the apparatus to establish a first wireless connection with a base station, receive an indication of a first TMSI for the UE, the first TMSI corresponding to a first set of POs for the UE that fail to satisfy a threshold timing value for the UE, transmit, to the base station, a registration request at least in part in response to receiving the indication of the first TMSI, receive a response to the registration request that indicates a second TMSI for the UE, and receive one or more paging messages from the base station in a second set of POs that correspond to the second TMSI.

Another apparatus for wireless communications at a UE is described. The apparatus may include means for establishing a first wireless connection with a base station, means for receiving an indication of a first TMSI for the UE, the first TMSI corresponding to a first set of POs for the UE that fail to satisfy a threshold timing value for the UE, means for transmitting, to the base station, a registration request at least in part in response to receiving the indication of the first TMSI, means for receiving a response to the registration request that indicates a second TMSI for the UE, and means for receiving one or more paging messages from the base station in a second set of POs that correspond to the second TMSI.

A non-transitory computer-readable medium storing code for wireless communications at a UE is described. The code may include instructions executable by a processor to establish a first wireless connection with a base station, receive an indication of a first TMSI for the UE, the first TMSI corresponding to a first set of POs for the UE that fail to satisfy a threshold timing value for the UE, transmit, to the base station, a registration request at least in part in response to receiving the indication of the first TMSI, receive a response to the registration request that indicates a second TMSI for the UE, and receive one or more paging messages from the base station in a second set of POs that correspond to the second TMSI.

Some examples of the method, apparatuses, and non-transitory computer-readable medium described herein may further include operations, features, means, or instructions for establishing the first wireless connection for a first subscriber identity module (SIM) and a second wireless connection for a second SIM, where the threshold timing value may be a first threshold timing value that may be compared to a first time interval between a PO of the first set of POs for the first SIM and a PO of a third set of POs for the second SIM.

In some examples of the method, apparatuses, and non-transitory computer-readable medium described herein, the first set of POs fail to satisfy the first threshold timing value based on the PO of the first set of POs being less than or equal to a threshold time interval from the PO of the third set of POs and the second set of POs satisfy the first threshold timing value based on a PO of the second set of POs being greater than or equal to the threshold time interval from the PO of the third set of POs.

In some examples of the method, apparatuses, and non-transitory computer-readable medium described herein, the PO of the first set of POs fails to satisfy the first threshold timing value based on at least a portion of the PO of the first set of POs overlapping in time with at least a portion of the PO of the third set of POs.

Some examples of the method, apparatuses, and non-transitory computer-readable medium described herein may further include operations, features, means, or instructions for identifying a second time interval associated with the UE receiving and processing an SSB and adjusting the first threshold timing value to be at least as long as the second time interval.

Some examples of the method, apparatuses, and non-transitory computer-readable medium described herein may further include operations, features, means, or instructions for receiving an SSB from the base station at a first time, where the threshold timing value may be a second threshold timing value that may be compared to a third time interval between the first time and a PO of the first set of POs.

In some examples of the method, apparatuses, and non-transitory computer-readable medium described herein, the PO of the first set of POs fail to satisfy the second threshold timing value based on the third time interval between the first time and the PO of the first set of POs being greater than or equal to the second threshold timing value.

In some examples of the method, apparatuses, and non-transitory computer-readable medium described herein, transmitting the registration request at least in part in response to receiving the indication of the first TMSI may include operations, features, means, or instructions for transmitting at least one additional registration request at least in part in response to the indication of the first TMSI, receiving at least one additional response corresponding to each of the at least one additional registration request, each additional registration response of the at least one additional registration response including an indication of an additional TMSI corresponding to a set of POs for the UE that fail to satisfy the threshold timing value for the UE, and transmitting the registration request at least in part in response to receiving the indication of the first TMSI and the indication of the additional TMSI.

Some examples of the method, apparatuses, and non-transitory computer-readable medium described herein may further include operations, features, means, or instructions for determining that the second set of POs for the UE fails to satisfy the threshold timing value and selectively transmitting one or more additional registration requests based on comparing a total number of transmitted registration requests to a threshold number of registration requests.

Some examples of the method, apparatuses, and non-transitory computer-readable medium described herein may further include operations, features, means, or instructions for transmitting the one or more additional registration requests based on determining that the total number of transmitted registration requests may be less than the threshold number of registration requests.

Some examples of the method, apparatuses, and non-transitory computer-readable medium described herein may further include operations, features, means, or instructions for refraining from transmitting the one or more additional registration requests based on determining that the total number of transmitted registration requests may be greater than or equal to the threshold number of registration requests and monitoring for the one or more paging messages from the base station according to the first set of POs based on the total number of transmitted registration requests being greater than or equal to the threshold number of registration requests.

In some examples of the method, apparatuses, and non-transitory computer-readable medium described herein, the threshold number of registration requests may be a quantity of one or more discontinuous reception (DRX) cycles.

In some examples of the method, apparatuses, and non-transitory computer-readable medium described herein, the first TMSI includes a first short TMSI and the second TMSI includes a second short TMSI, the first short TMSI including an access and mobility management function (AMF) set identifier, an AMF pointer, and a first fifth generation (5G) TMSI, and the second short TMSI including the AMF set identifier, the AMF pointer, and a second 5G TMSI.

### BRIEF DESCRIPTION OF THE DRAWINGS

FIGS. 1 and 2 illustrate examples of wireless communications systems that support paging occasion (PO) update using a registration request in accordance with aspects of the present disclosure.

FIG. 3 illustrates an example of a process flow that supports PO update using a registration request in accordance with aspects of the present disclosure.

FIG. 4 illustrates an example of a resource diagram that supports PO update using a registration request in accordance with aspects of the present disclosure.

FIG. 5 illustrates an example of a process flows that supports PO update using a registration request in accordance with aspects of the present disclosure.

FIGS. 6 and 7 show block diagrams of devices that support PO update using a registration request in accordance with aspects of the present disclosure.

FIG. 8 shows a block diagram of a communications manager that supports PO update using a registration request in accordance with aspects of the present disclosure.

FIG. 9 shows a diagram of a system including a device that supports PO update using a registration request in accordance with aspects of the present disclosure.

FIGS. 10 through 12 show flowcharts illustrating methods that support PO update using a registration request in accordance with aspects of the present disclosure.

### DETAILED DESCRIPTION

In some wireless communications systems, a base station may transmit a paging message to a user equipment (UE) to indicate to the UE that the base station has data to transmit to the UE. To save power when not actively communicating, a UE may sleep but awaken to monitor for paging messages according to a discontinuous reception (DRX) cycle. For example, the base station may transmit the paging message at a paging occasion (PO) in a paging frame (PF) (e.g., at a subframe within a radio frame for paging). The UE may monitor the PO during an on duration of a DRX cycle, where the DRX cycle includes the on duration in which the UE is in an active state and an off duration in which the UE is in a sleep or idle state. In some examples, the base station and the UE may calculate the PF and the PO using a formula including one or more parameters, such as a temporary mobile subscription identifier (TMSI). The base station may assign the TMSI for the UE upon registration, such that the timing of POs for the UE are based on the assigned TMSI. However, there may be timing conflicts for the PO. For example, when the UE is a multi-subscriber identity module (MSIM) device (e.g., with multiple subscriptions), one or more subscriptions may share a radio frequency (RF) resource. There may be a collision between POs of the two subscriptions, and a subscription may miss a paging message from the base station. In another example, a UE may awaken to monitor POs and also separately awaken to monitor for synchronization signal blocks (SSBs).

As described herein, a UE may transmit a registration request to a base station to trigger a transmission of a new TMSI to update the timing of POs for paging messages. In some cases, the UE may establish a connection with a base station and may receive a TMSI identifying a PO for a periodic set of POs. In some cases, the PO may not satisfy a threshold timing value. That is, the PO may collide with another PO for a different subscription if the UE is a MSIM device. Or, the PO may be too far from an SSB for the UE to perform a wakeup operation to monitor for the paging messages and the SSB. Thus, the UE may transmit a registration request to the base station, and the base station may respond with a new TMSI, which indicates another PO or another set of POs. The UE may determine whether the new PO satisfies the threshold timing value. If the new PO does not satisfy the threshold timing value, the UE may continue to transmit registration requests to the base station until the threshold is satisfied or until a limit number of transmitted registration requests is reached (e.g., where the limit is based on the transmitted registration request for one or more DRX cycles). If the new PO satisfies the threshold timing value, the UE may monitor the new PO for the paging messages. However, once a threshold number, or limit, of transmitted registration requests is reached, the UE may abandon its attempts to obtain a better PO timing and monitor the original PO for the paging messages.

Although the techniques herein are described with reference to a TMSI, other identifiers that determine an occasion, period, interval, or other timing for the UE to monitor for paging messages (e.g., group, multicast, unicast, or broadcast paging messages) or other indications from the base station or network that data is available to be transmitted to the UE (e.g., paging) may be used. For example, where an identifier associated with the UE is used to determine POs, the UE may provide signaling to the base station triggering the base station to update such identifier. In some examples, such identifiers may be associated with a subscription (e.g., be a subscription identifier), or may be associated with the UE, or both.

Although a registration request is described herein, the techniques described herein may be applied to other signaling from the UE to the base station that requests or otherwise triggers the base station, network, or both, to provide the UE with an updated identifier or other indication of the timing for the UE to receive paging (e.g., POs).

Aspects of the disclosure are initially described in the context of wireless communications systems. Aspects of the disclosure are further described in the context of a resource diagram and process flows. Aspects of the disclosure are further illustrated by and described with reference to apparatus diagrams, system diagrams, and flowcharts that relate to PO update using a registration request.

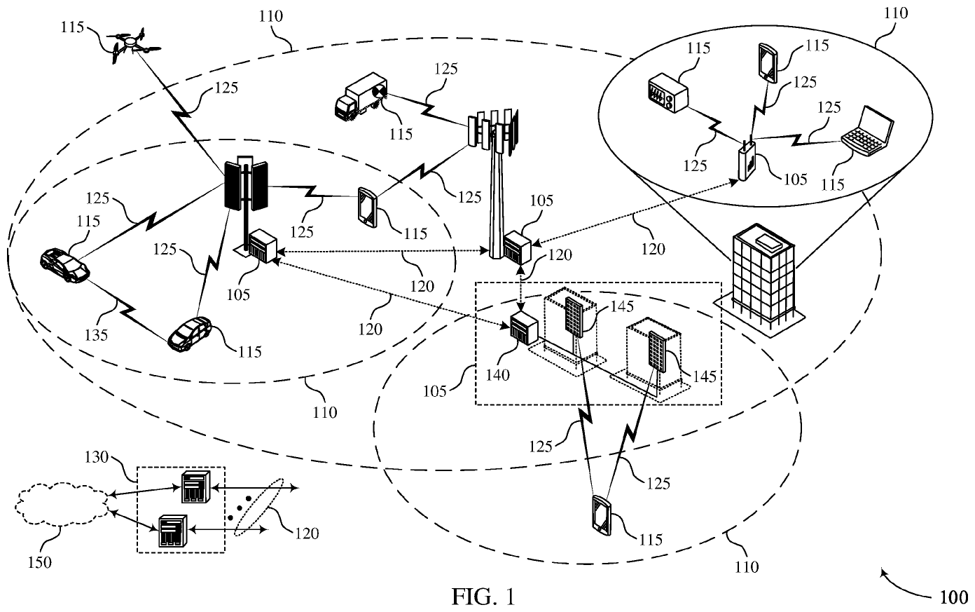

FIG. 1 illustrates an example of a wireless communications system 100 that supports PO update using a registration request in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz. Devices in wireless communications system 100 may communicate over unlicensed spectrum, such as the 5 GHz band, the 2.4 GHz band, the 60 GHz band, the 3.6 GHz band, or the 900 MHz band. The unlicensed spectrum may also include other frequency bands.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARM) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a base station 105 and a UE 115 may establish a connection for communication using an RRC protocol. For example, the UE 115 may operate in different RRC states, such as an RRC connected state, an RRC inactive state, an RRC idle state, or the like. In some cases, the UE 115 may establish a connection, such as an RRC connection, with the base station 105 and may move to an RRC idle or RRC inactive state (e.g., from an RRC active state), and monitor for one or more paging messages from the base station 105 according to a DRX cycle. For example, each DRX cycle may have an on duration during which the UE 115 is awake and actively monitoring for paging messages and an off duration in which the UE 115 is in a reduced power mode. Each DRX cycle may include a number of POs and a number of PFs. For example, the DRX cycle include a number of subframes in a radio frame for paging messages, and the subframes may be referred to as POs and the radio frame may be a PF. In some examples, the UE 115 may calculate a PF and PO for one or more paging messages using a formula including one or more parameters, such as a TMSI. However, the PO may fail to satisfy a threshold (e.g., a threshold timing value) timing relative to one or more occasions, for example one or more occasions for the UE 115 to monitor for signaling from the network (e.g., paging, synchronization signal blocks, etc.).

In some cases, the UE 115 may monitor for one or more paging messages during one or more POs and for an SSB during an SSB window within the radio frame. Thus, if the PO and the SSB window are far apart in time, the UE 115 may be waking up multiple times per on duration of the DRX cycle to monitor for signaling or messages from the base station, which may increase power consumption at the UE 115 related to the wake up procedure. Additionally or alternatively, the UE 115 may be an MSIM device operating according to multiple SIMS for multiple subscriptions that share RF resources. In some cases, the UE 115 may not be capable of decoding a paging message from multiple subscriptions at a same time. However, the base station 105 may be unaware of the POs scheduled on the multiple subscriptions when scheduling POs for each subscription. Thus, there may be one or more conflicts between POs for different subscriptions, and the UE 115 may miss paging messages.

In some examples, to reduce timing conflicts related to monitoring during POs, the UE 115 may transmit one or more additional registration request if a PO calculated based on a TMSI indication fails to satisfy the threshold timing value (e.g., is too close to a PO for another subscription, is too far away from an SSB window, or both). The base station 105 may transmit a new TMSI in response to the registration request, and the UE 115 may update a PF and PO using the new TMSI value. The new PO may satisfy the threshold timing value by resolving timing conflicts for multiple subscriptions or may satisfy the threshold timing value by moving the PO in which the UE 115 monitors for paging messages closer to an SSB window. In some cases, the UE 115 may continue to transmit additional registration requests until a PO satisfies the threshold timing value for either an SSB window, a PO for another subscription, or both, or until reaching a limit for a total number of registration requests.

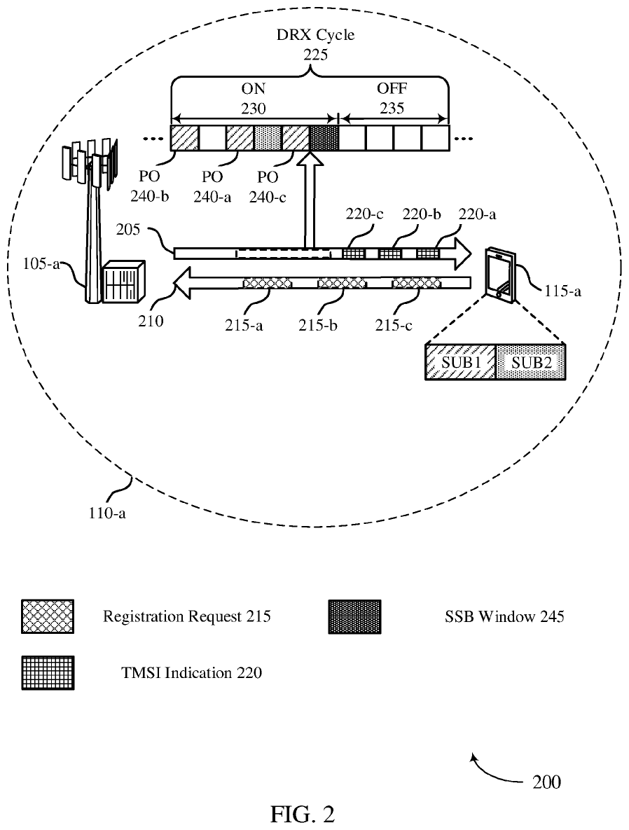

FIG. 2 illustrates an example of a wireless communications system 200 that supports PO update using a registration request in accordance with aspects of the present disclosure. In some examples, wireless communications system 200 may implement aspects of wireless communications system 100 and may include UE 115-a and base station 105-a with coverage area 110-a, which may be examples of a UE 115 and a base station 105 with a coverage area 110 as described with reference to FIG. 1. In some examples, base station 105-a and UE 115-a may communicate control signaling, data, or both using downlink communication link 205 and uplink communication link 210. For example, UE 115-a may transmit a registration request 215 (e.g., registration request 215-a) via uplink communication link 210 to base station 105-a to initiate a registration procedure for communications with base station 105-a. Similarly, base station 105-a may transmit a registration accept message to UE 115-a via downlink communication link 205, where the registration accept message may include a TMSI indication 220.

In some examples, a base station 105 and a UE 115 may communicate using RRC protocol. For example, UE 115-a may operate in different RRC states, such as an RRC connected state, an RRC inactive state, an RRC idle state, or the like. In some cases, such as when UE 115-a is in the RRC idle or RRC inactive state, UE 115-a may periodically monitor for one or more paging messages from base station 105-a. UE 115-a may establish a connection, such as an RRC connection, with base station 105-a based on receiving a paging message from base station 105-a that triggers RRC connection setup (e.g., a mobile terminated voice call). When UE 115-a establishes a connection with base station 105-a, UE 115-a may move from an idle state to a connected state. After establishing the connection with base station 105-a, UE 115-a may transition to (e.g., back to) an RRC idle or RRC inactive state.

In some cases, UE 115-a may monitor for paging messages while in an RRC idle or RRC inactive state according to a DRX cycle 225. Each DRX cycle may have an on duration 230 during which UE 115-a is awake and actively monitoring one or more channels and an off duration 235 in which UE 115-a is in a reduced power mode (e.g., a sleep mode) to reduce power consumption. In some examples, the periodicity of each DRX cycle 225 may be configured by base station 105-a, may be predetermined at UE 115-a, or may be otherwise signaled to UE 115-a. Each DRX cycle 225 may include a number of subframes in a radio frame for paging messages. The subframes may be referred to as POs 240 and the radio frame may be a PF. UE 115-a may monitor the PO periodically for a set of POs.

In some examples, UE 115-a may calculate a PF and PO 240 for one or more paging messages using a formula including one or more parameters, such as a TMSI. For example, UE 115-a may determine a shortened-TMSI (S-TMSI) for 5G NR operation based on Equation 1:

5G_S_TMSI:=AMFSetID×AMFPointer×5G_TMSI (1)

where the access and mobility management function (AMF) set identifier (ID) is an 8 bit value, the AMF pointer is an 8 bit value, and the TMSI is a 32 bit value. In some cases, UE 115-a may determine a system frame number (SFN) for a PF based on Equation 2:

$$( S F N + P {F}_{Offset} ) mod ( T ) = \frac{T}{N} \times U {E}_{ID} mod ( N ) \qquad ( 2 )$$

where T is based on the DRX cycle 225 of UE 115-a, N is a number of total PFs in T, PF_{offset} is an offset UE 115-a uses for PF determination, and the UE ID is the 5G_S_TMSImod(1024). In some examples, T may be the shortest of one or more UE-specific DRX values if configured by RRC, upper layers, or both or may be a default DRX value broadcast in system information if UE 115-a is in an RRC idle state and the UE-specific DRX value is not configured by upper layers.

In some examples, UE 115-a may determine an index of the PO 240, iₛ, based on Equation 3:

$${i}_{s} = floor ( \frac{{UE}_{ID}}{N} mod ( {N}_{S} ) \qquad ( 3 )$$

where Nₛ is a number of POs 240 for a PF. Thus, UE 115-a may perform one or more calculations according to Equations 1-3 to determine a PF and an index for a PO 240 in a set of POs 240.

In some examples, base station 105-a may transmit one or more paging messages during the POs 240. Thus, UE 115-a may monitor one or more POs 240 during the on duration 230 of the DRX cycle 225. Additionally or alternatively, base station 105-a may schedule one or more synchronization signals during SSB windows 245 located within the radio frame during the on duration 230. In some cases, UE 115-a may wake up to monitor for one or more paging messages during one or more POs 240 in the on duration 230. Similarly, UE 115-a may wake up to monitor for synchronization signals during the SSB windows 245 in the on duration 230. Thus, if the PO 240 and the SSB window 245 are far apart in time, UE 115-a may be waking up multiple times per on duration 230 to monitor for signaling or messages from base station 105-a, which may increase power consumption at UE 115-a related to the wake up procedure.

Additionally or alternatively, UE 115-a may be an MSIM device operating according to multiple SIMS for multiple subscriptions (e.g., Subscription 1 (SUB1) and Subscription 2 (SUB2)). For example, SUB1 and SUB2 may use different operators but may share RF resources. In some cases, UE 115-a may not be capable of decoding a paging message from SUB1 and SUB2 at a same time when both SUB1 and SUB2 are in an RRC idle or RRC inactive state. However, base station 105-a may be unaware of the POs 240 scheduled on SUB2 when scheduling POs 240 for SUB1. Thus, there may be one or more conflicts between POs 240 for SUB1 and POs 240 for SUB2, and UE 115-a may miss a paging message from either subscription.

In some examples, a PO 240 for a TMSI from an initial registration request may have a timing conflict with an SSB window 245, a PO 240 from another subscription, or both. For example, PO 240-a for a TMSI indicated by TMSI indication 220-a in a registration accept for registration request 215-a (e.g., from an initial registration procedure between UE 115-a and base station 105-a), may fail to satisfy a threshold timing value. That is, the duration between PO 240-a and a PO 240 for SUB2 may be less than the threshold timing value (e.g., too close together in time), such that there may be a resource collision for PO 240-a for SUB1 and the PO 240 for SUB2. Additionally or alternatively, the duration between PO 240-a and an SSB window 245 may be greater than the threshold timing value (e.g., too far apart in time), such that UE 115-a may wake up multiple times to monitor for each of PO 240-a and the SSB window 245 rather than once to monitor for both.

In some examples, to reduce timing conflicts related to monitoring during POs 240, UE 115-a may transmit one or more additional registration request 215 if a PO 240 based on a TMSI indication 220 fails to satisfy a threshold timing value (e.g., is too close to a SUB2 PO 240, is too far away from an SSB window 245, or both). Base station 105-a may transmit a new TMSI in response to the registration request 215. UE 115-a may update a PF and PO 240, for example according to Equations 1-3, using the new TMSI value, which may resolve any timing conflicts related to the original PO 240. For example, UE 115-a may transmit registration request 215-a during an initial registration procedure for SUB1 with base station 105-a. Base station 105-a may transmit TMSI indication 220-a indicating an initial TMSI value that identifies PO 240-a for a paging message. In some cases, UE 115-a may determine PO 240-a fails to satisfy a threshold timing value. That is, UE 115-a may determine PO 240-a uses resources overlapping with a PO 240 for SUB2, UE 115-a may determine PO 240-a is too far apart from an SSB window 245 to monitor for the paging message and SSB during a wakeup procedure, or both.

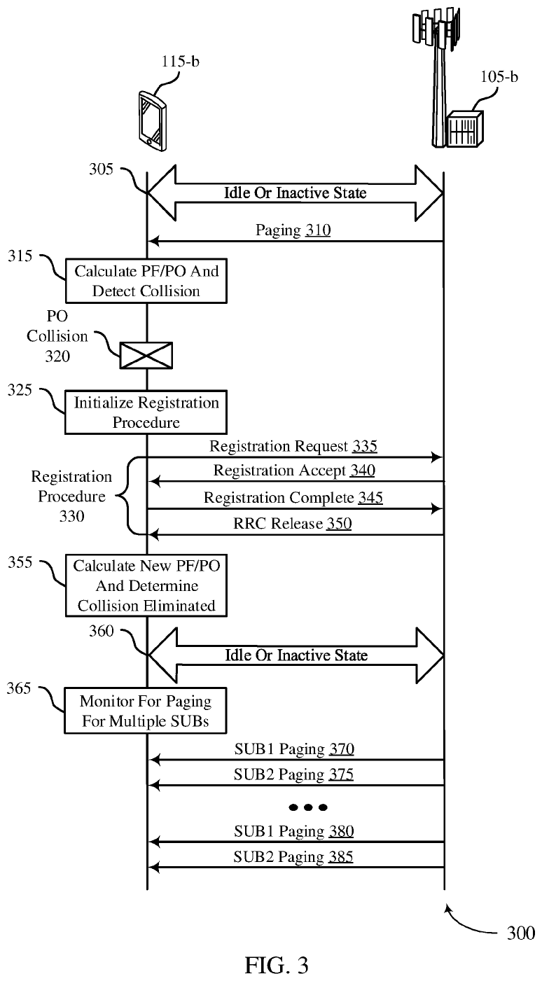

In some examples, UE 115-a may transmit one or more additional registration request 215 to base station 105-a based on determining PO 240-a fails to satisfy the threshold timing value. For example, if PO 240-a is close enough to a PO 240 for SUB2, such that UE 115-a may be unable to switch resources to monitor for both PO 240-a and a PO for SUB2, UE 115-a may transmit registration request 215-b to base station 105-a. Base station 105-a may transmit TMSI indication 220-b for a new TMSI value based on receiving registration request 215-b. The new TMSI value may identify PO 240-b as a new PO 240 for monitoring for paging messages from base station 105-a for SUB1. PO 240-b may satisfy the threshold timing value by resolving timing conflicts for SUB1 and SUB2, which is described in further detail with respect to FIG. 3 (e.g., UE 115-a may be capable of monitoring for paging messages for SUB1 during PO 240-b and SUB2 during a PO for SUB2).

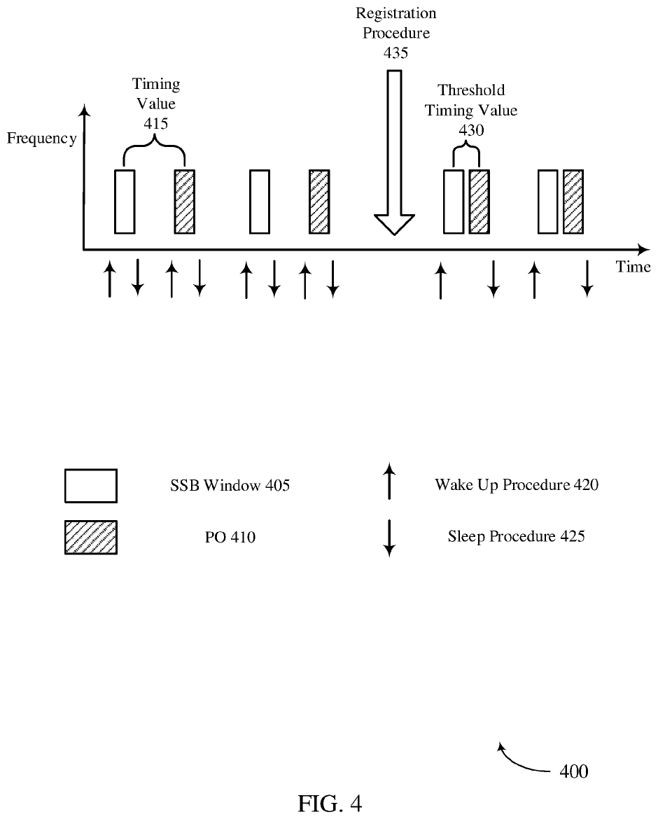

Additionally or alternatively, if the duration between PO 240-a and the SSB window 245 is relatively long, such that UE 115-a wakes up to monitor for PO 240-a, enters a sleep mode, then wakes up again to monitor for the SSB during the SSB window 245, UE 115-a may transmit registration request 215-c to base station 105-a. Base station 105-a may transmit TMSI indication 220-c for a new TMSI value based on receiving registration request 215-c. The new TMSI value may identify PO 240-c as a new PO 240 for monitoring for paging messages from base station 105-a. PO 240-c may satisfy the threshold timing value by moving the PO 240 in which UE 115-a monitors for paging messages closer to an SSB window 245, such that UE 115-a may wake up and monitor for both the paging messages during PO 240-c and the SSB during the SSB window 245, which is described in further detail with respect to FIG. 4. In some examples, UE 115-a may measure an SSB (e.g., a cell SSB) when in an RRC idle state. Thus, UE 115-a may find a PO 240 near an SSB window 245 (e.g., an SSB location) to reduce power consumption related to waking up for monitoring during the DRX on duration 230.

In some examples, reducing collisions for paging messages for multiple SUBS may allow UE 115-a to decode network paging (e.g., paging messages from base station 105-a during POs 240) and respond with RRC connection with reduced interference, or without interference. Additionally or alternatively, if UE 115-a may adjust POs 240 for monitoring for paging messages, UE 115-a may reduce RF resource interference, hardware usage (e.g., by implementing a software method), or both to save costs while reduce power consumption by decreasing UE wakeup time.

In some cases, UE 115-a may continue to transmit additional registration requests 215 until a PO 240 for SUB1 identified by a TMSI from a TMSI indication 220 from base station 105-a satisfies the threshold timing value for either an SSB window 245, a PO 240 for SUB2, or both. In some other cases, UE 115-a may continue to transmit one or more additional registration requests 215 until reaching a limit total number (e.g., threshold number or quantity) of registration requests 215. The limit total number of registration requests 215 may be indicated to UE 115-a via control signaling from base station 105-a, may be a predetermined value, may be determined by UE 115-a, or the like. The limit total number of registration requests 215 may be per DRX cycle 225.

FIG. 3 illustrates an example of a process flow 300 that supports PO update using a registration request in accordance with aspects of the present disclosure. In some examples, process flow 300 may implement aspects of wireless communications system 100 and wireless communications system 200. The process flow 300 may illustrate an example of UE 115-b transmitting one or more additional registration requests to base station 105-b to eliminate one or more resource collisions for POs for different subscriptions at UE 115-b. Alternative examples of the following may be implemented, where some processes are performed in a different order than described or are not performed. In some cases, processes may include additional features not mentioned below, or further processes may be added.

In some examples, UE 115-b may be in an idle or inactive state, such as an RRC idle state or RRC inactive state according to an RRC protocol. UE 115-b may initiate a registration procedure with base station 105-b prior to entering into the idle or inactive state at 305. For example, UE 115-b may transmit a registration request to base station 105-b. Base station 105-b may respond with a registration accept, which may include an indication of a TMSI value that UE 115-b may use to calculate a set of POs for one or more paging messages from base station 105-b. For example, UE 115-b may determine one or more POs per DRX cycle in which to periodically monitor for paging messages from base station 105-b.

At 310, base station 105-b may transmit one or more paging messages to UE 115-b during at least on PO. UE 115-a may calculate a PF and a PO based on the TMSI from the registration procedure.

At 315 and 320, UE 115-b may determine there is a collision between POs for multiple subscriptions. For example, one or more POs for different subscriptions may overlap, may be close in time such that UE 115-b may be unable to switch resource to monitor for the paging messages in each PO, or both. In some examples, a lower layer (e.g., a first lower layer (L1)) may calculate the PF and PO for each subscription and may detect the PO collision.

Thus, at 325, UE 115-b may initialize an additional registration procedure 330. For example, a subscription of UE 115-b may trigger an RRC registration request with type mobility registration updating based on lower layer indication. UE 115-b may change the PF and PO for monitoring for paging messages by updating the TMSI (e.g., a 5G-S-TMSI) through initializing the registration procedure 330. The registration procedure 330 may involve UE 115-b transmitting a registration request at 335. At 340, base station 105-b may transmit a registration accept including an indication of a new TMSI. At 345 and 350, UE 115-b may transmit a registration complete message and base station 105-b may transmit an RRC release message, respectively.

At 355, UE 115-b may calculate a new PF and PO based on the new TMSI. For example, the lower layer (e.g., L1) may calculate the new PF and PO based on the new 5G-S-TMSI.

In some cases, UE 115-b may determine if the one or more collisions between POs is eliminated. If so, UE 115-b may enter an idle or inactive state at 360, and at 365, may monitor for paging for multiple subscriptions (e.g., SUB1 and SUB2).

In some examples, UE 115-b may monitor for paging normally. For example, at 370, UE 115-b may receive one or more paging messages during a PO for SUB1. At 375, UE 115-b may receive one or more paging message during a PO for SUB2. In some examples, UE 115-b may continue to receive paging messages for SUB1 and SUB2 (e.g., periodically according to a DRX cycle), until at 380 and at 385, UE 115-b receives a final paging message for SUB1 and SUB2, respectively.

FIG. 4 illustrates an example of a resource diagram 400 that supports PO update using a registration request in accordance with aspects of the present disclosure. In some examples, resource diagram 400 may implement aspects of wireless communications system 100 and wireless communications system 200. For example, resource diagram 400 may be implemented by a UE 115 and a base station 105 as described with reference to FIGS. 1 and 2. In some cases, a base station may schedule an SSB during an SSB window 405 and one or more paging messages during a PO 410 during an on duration of a DRX cycle at a UE.

In some cases, a timing value 415 between an SSB window 405 and a PO 410 may be such that a UE performs a wakeup procedure 420 and a sleep procedure 425 for both the SSB window 405 and the PO 410. For example, the SSB window 405 and the PO 410 may be far enough apart in time that the UE may wake up twice to monitor for an SSB and one or more paging messages, respectively. In some examples, a lower layer (e.g., L1) at the UE may calculate the timing value 415, which may be a distance between a PF, a PO 410, or both and the corresponding SSB window 405. If the timing value 415 is larger than a threshold timing value 430, such that the UE wakes up and sleeps twice, the UE may trigger a registration procedure 435 to reset the PF and PO. The UE may initiate the registration procedure 435 with a registration type as mobility registration updating.

In some examples, the base station may assign the UE a new TMSI value during the registration procedure 435, which may adjust the PF and PO 410 to satisfy the threshold timing value 430. For example, the new PO 410 may be close enough to an SSB window 405 for the UE to perform a signal wakeup procedure 420 and sleep procedure 425 to monitor for both the SSB and the one or more paging messages for PO 410. In some cases, if the adjusted PO 410 does not satisfy the threshold timing value 430 (e.g., the PO 410 is still too far from the SSB window 405), the UE may send additional registration requests to initiate additional registration procedures 435. The UE may continue to transmit additional registration requests until the PO 410 satisfies the threshold timing value 430 or until reaching a limit total number of registration requests. The limit total number of registration requests may be per DRX cycle and may be configured at the UE or predetermined (e.g., based on an encrypted file system (EFS) file).

Although a single SSB window having a particular periodicity is described with reference to resource diagram 400, other numbers of SSB windows 405, and combinations with POs 410 may also be used consistent with the techniques described herein. For example, there may be two instances of a POs 410 between each instance of an SSB window 405. In other examples, there may be one instances of SSB windows 405 between each instance of a PO 410. Moreover, resource diagram illustrates a single set of POs 410. However, multiple sets of POs 410 (e.g., a first set for a SUB1 and a second set for a SUB2) may be present with SSB windows 405, such that the techniques described herein may be extended to provide for a new PO 410 for one set that may be close enough to an SSB window 405 for the UE to perform a signal wakeup procedure 420 and sleep procedure 425 to monitor for both the SSB and the one or more paging messages of PO 410, while also avoid conflicts between POs 410 of different sets (e.g., for SUB1 and SUB2).

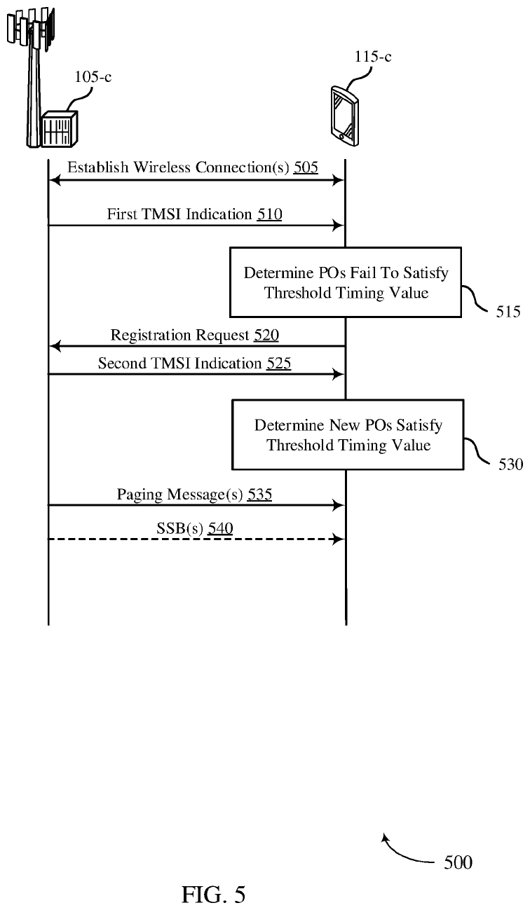

FIG. 5 illustrates an example of a process flow 500 that supports PO update using a registration request in accordance with aspects of the present disclosure. In some examples, process flow 500 may implement aspects of wireless communications system 100, wireless communications system 200, process flow 300, and resource diagram 400. The process flow 500 may illustrate an example of a UE 115-c transmitting one or more registration requests to base station 105-c to update a PO to resolve timing conflicts for an initial PO. Alternative examples of the following may be implemented, where some processes are performed in a different order than described or are not performed. In some cases, processes may include additional features not mentioned below, or further processes may be added.

At 505, UE 115-c may establish one or more wireless connections with base station 105-c. For example, UE 115-c may establish a wireless connection for each SIM with a different subscription if UE 115-c is an MSIM device. In some cases, UE 115-c may perform a registration procedure with base station 105-b to establish the wireless connection. Thus, UE 115-c may transmit an initial registration request to base station 105-c.

At 510, base station 105-c may transmit an indication of a first TMSI to UE 115-c. The indication may be in response to an initial registration request from UE 115-c. The UE may calculate one or more POs (e.g., a PO per DRX on duration) to monitor for one or more paging messages from base station 105-c. The one or more POs may be periodic based on the DRX cycle of UE 115-c.

At 515, UE 115-c may determine the POs fail to satisfy a threshold timing value. In some cases, if UE 115-c is an MSIM device, UE 115-c may compare the threshold timing value to a time interval between POs for different SIMS. UE 115-c may determine the POs fail to satisfy the timing threshold value if the different POs for each SIM are too close together in time (e.g., if UE 115-c is unable to monitor during both POs). That is, the POs may fail to satisfy the threshold timing value based on the PO for a SIM being less than or equal to a threshold time interval from the PO of another SIM. In some other cases, POs may fail to satisfy the threshold timing value based on at least a portion of the PO of a SIM overlapping in time with at least a portion of a PO of another SIM. Additionally or alternatively, UE 115-c may adjust the threshold timing value based on a time interval associated with the UE receiving and processing an SSB from base station 105-b. That is, the threshold timing value may be at least as long as the time interval.

In some examples, UE 115-c may determine the POs fail to satisfy the threshold timing value based on comparing a time interval between the POs and an SSB window. For example, if the POs are too far from the SSB window, such that UE 115-c may perform a wake up procedure for both the PO and the SSB window, UE 115-c may determine the PO fails to satisfy the threshold timing value. That is, the POs may fail to satisfy the threshold timing value based on the time interval between the POs and the SSB window being greater than or equal to the threshold timing value.

At 520, UE 115-c may transmit a registration request to base station 105-c to initialize a registration procedure. UE 115-c may transmit the registration request at least in part in response to receiving the indication of the TMSI (e.g., based on one or more calculated POs failing to satisfy the threshold timing value).

At 525, UE 115-c may receive a response to the registration request that indicates a new TMSI for UE 115-c. UE 115-c may calculate an updated PO for a set of POs based on the new TMSI.

In some examples, at 530, UE 115-c may determine the new POs satisfy the threshold timing value. For example, UE 115-c may determine the new POs satisfy the threshold timing value based on the updated PO of the set of POs being greater than or equal to the threshold time interval from the updated PO to a set of POs for another SIM. In some other examples, UE 115-c may determine the new POs satisfy the threshold timing value based on the updated PO of the set of POs being less than the threshold time interval from the updated PO to an SSB window.

In some cases, UE 115-c may determine the new POs fail to satisfy the threshold timing value. UE 115-c may transmit additional registration requests and may receive additional responses for each of the additional registration requests. Each additional registration response may include an indication of an additional TMSI for a set of POs for the UE 115-c that fail to satisfy the threshold timing value. UE 115-c may continue to transmit the registration requests until the POs satisfy the threshold timing value or until a total number of transmitted registration requests reaches a threshold, or limit, number of registration requests. In some cases, the threshold number of registration requests may be per DRX cycle of UE 115-c. In some examples, UE 115-c may transmit additional registration requests based on determining that the total number of transmitted registration requests is less than the threshold number of registration requests. In some other examples, UE 115-c may refrain from transmitting additional registration requests based on determining that the total number of transmitted registration requests is greater than or equal to the threshold number of registration requests. If UE 115-c reaches the threshold number of registration requests, UE 115-c may monitor for one or more paging messages from base station 105-c according to the initial POs.

At 535, UE 115-c may monitor for and receive the one or more paging messages from base station 105-c in the updated set of POs for the new TMSI.

At 540, UE 115-c may monitor for and receiving an SSB from base station 105-c within a same wake up time window as monitoring for the one or more paging messages.

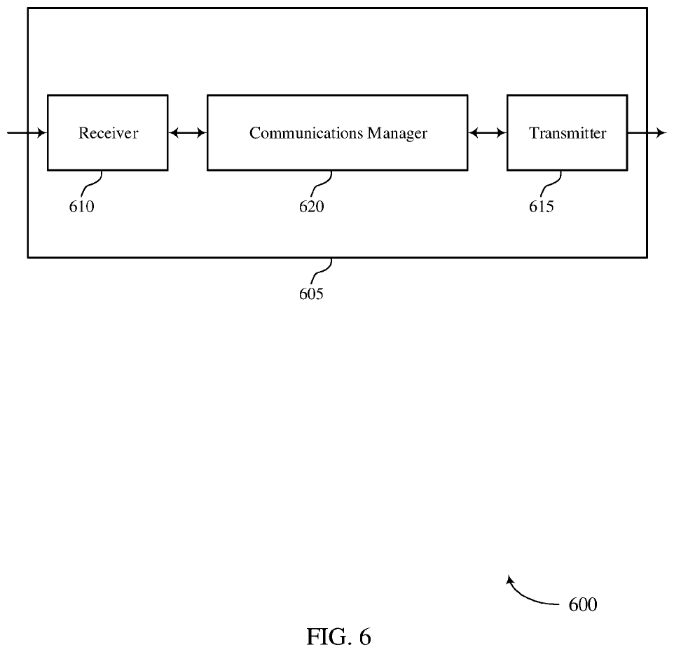

FIG. 6 shows a block diagram 600 of a device 605 that supports PO update using a registration request in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to PO update using a registration request). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PO update using a registration request). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of PO update using a registration request as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a one or more processors, memory coupled with the one or more processors, and instructions stored in the memory that are executable by the one or more processors to enable the one or more processors to perform the PO update using a registration request features discussed herein. The hardware may also include a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for establishing a first wireless connection with a base station. The communications manager 620 may be configured as or otherwise support a means for receiving an indication of a first TMSI for the UE, the first TMSI corresponding to a first set of POs for the UE that fail to satisfy a threshold timing value for the UE. The communications manager 620 may be configured as or otherwise support a means for transmitting, to the base station, a registration request at least in part in response to receiving the indication of the first TMSI. The communications manager 620 may be configured as or otherwise support a means for receiving a response to the registration request that indicates a second TMSI for the UE. The communications manager 620 may be configured as or otherwise support a means for receiving one or more paging messages from the base station in a second set of POs that correspond to the second TMSI.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for a UE to transmit additional registration requests to a base station to update one or more POs to satisfy a threshold timing value, which may reduce processing, reduce power consumption, cause more efficient utilization of communication resources, and more.

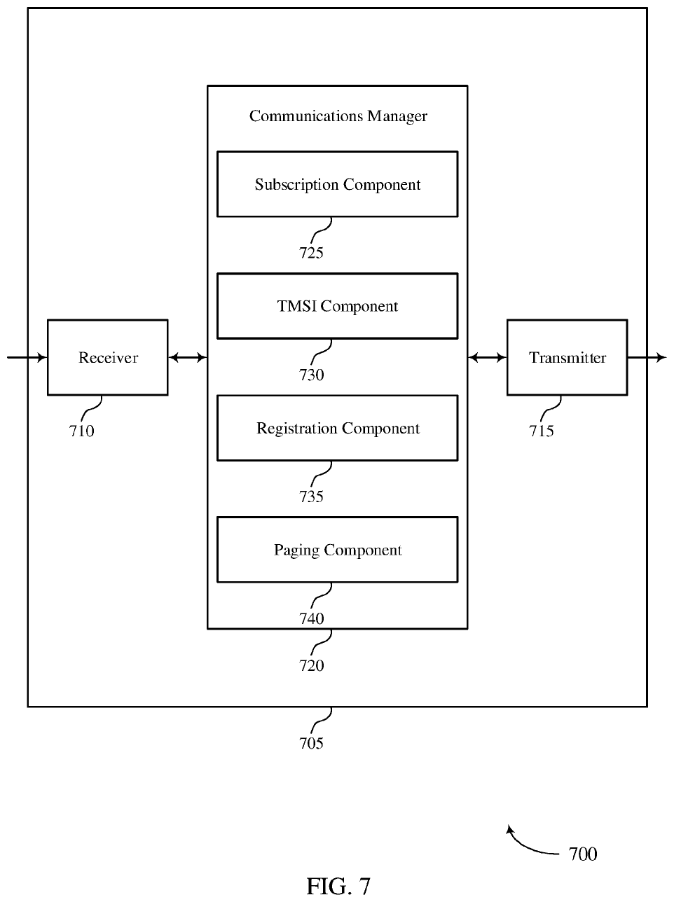

FIG. 7 shows a block diagram 700 of a device 705 that supports PO update using a registration request in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to PO update using a registration request). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PO update using a registration request). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of PO update using a registration request as described herein. For example, the communications manager 720 may include a subscription component 725, an TMSI component 730, a registration component 735, a paging component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The subscription component 725 may be configured as or otherwise support a means for establishing a first wireless connection with a base station. The TMSI component 730 may be configured as or otherwise support a means for receiving an indication of a first TMSI for the UE, the first TMSI corresponding to a first set of POs for the UE that fail to satisfy a threshold timing value for the UE. The registration component 735 may be configured as or otherwise support a means for transmitting, to the base station, a registration request at least in part in response to receiving the indication of the first TMSI. The TMSI component 730 may be configured as or otherwise support a means for receiving a response to the registration request that indicates a second TMSI for the UE. The paging component 740 may be configured as or otherwise support a means for receiving one or more paging messages from the base station in a second set of POs that correspond to the second TMSI.

In some cases, the subscription component, TMSI component, registration component, the paging component, or a combination thereof may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the subscription component, TMSI component, registration component, the paging component, or a combination thereof discussed herein. A transceiver processor may be collocated with or communicate with (e.g., direct the operations of) a transceiver of the device. A radio processor may be collocated with or communicate with (e.g., direct the operations of) a radio (e.g., an NR radio, an LTE radio, a Wi-Fi radio) of the device. A transmitter processor may be collocated with or communicate with (e.g., direct the operations of) a transmitter of the device. A receiver processor may be collocated with or communicate with (e.g., direct the operations of) a receiver of the device.

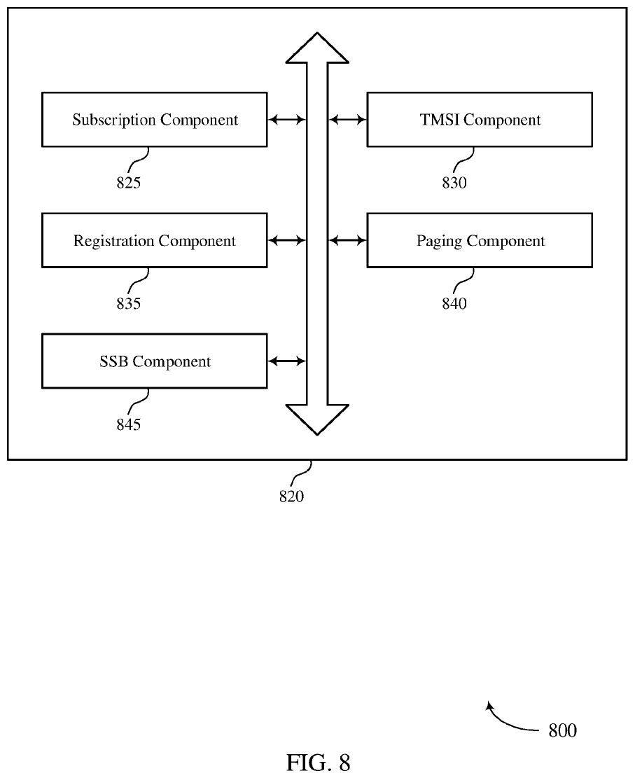

FIG. 8 shows a block diagram 800 of a communications manager 820 that supports PO update using a registration request in accordance with aspects of the present disclosure. The communications manager 820 may be an example of aspects of a communications manager 620, a communications manager 720, or both, as described herein. The communications manager 820, or various components thereof, may be an example of means for performing various aspects of PO update using a registration request as described herein. For example, the communications manager 820 may include a subscription component 825, an TMSI component 830, a registration component 835, a paging component 840, an SSB component 845, or any combination thereof. Each of these components may communicate, directly or indirectly, with one another (e.g., via one or more buses).

The communications manager 820 may support wireless communications at a UE in accordance with examples as disclosed herein. The subscription component 825 may be configured as or otherwise support a means for establishing a first wireless connection with a base station. The TMSI component 830 may be configured as or otherwise support a means for receiving an indication of a first TMSI for the UE, the first TMSI corresponding to a first set of POs for the UE that fail to satisfy a threshold timing value for the UE. The registration component 835 may be configured as or otherwise support a means for transmitting, to the base station, a registration request at least in part in response to receiving the indication of the first TMSI. In some examples, the TMSI component 830 may be configured as or otherwise support a means for receiving a response to the registration request that indicates a second TMSI for the UE. The paging component 840 may be configured as or otherwise support a means for receiving one or more paging messages from the base station in a second set of POs that correspond to the second TMSI.

In some examples, the subscription component 825 may be configured as or otherwise support a means for establishing the first wireless connection for a first SIM and a second wireless connection for a second SIM, where the threshold timing value is a first threshold timing value that is compared to a first time interval between a PO of the first set of POs for the first SIM and a PO of a third set of POs for the second SIM.

In some examples, the first set of POs fail to satisfy the first threshold timing value based on the PO of the first set of POs being less than or equal to a threshold time interval from the PO of the third set of POs. In some examples, the second set of POs satisfy the first threshold timing value based on a PO of the second set of POs being greater than or equal to the threshold time interval from the PO of the third set of POs.

In some examples, the PO of the first set of POs fails to satisfy the first threshold timing value based on at least a portion of the PO of the first set of POs overlapping in time with at least a portion of the PO of the third set of POs.

In some examples, the SSB component 845 may be configured as or otherwise support a means for identifying a second time interval associated with the UE receiving and processing an SSB. In some examples, the SSB component 845 may be configured as or otherwise support a means for adjusting the first threshold timing value to be at least as long as the second time interval.

In some examples, the SSB component 845 may be configured as or otherwise support a means for receiving an SSB from the base station at a first time, where the threshold timing value is a second threshold timing value that is compared to a third time interval between the first time and a PO of the first set of POs.

In some examples, the PO of the first set of POs fail to satisfy the second threshold timing value based on the third time interval between the first time and the PO of the first set of POs being greater than or equal to the second threshold timing value.

In some examples, to support transmitting the registration request at least in part in response to receiving the indication of the first TMSI, the registration component 835 may be configured as or otherwise support a means for transmitting at least one additional registration request at least in part in response to the indication of the first TMSI. In some examples, to support transmitting the registration request at least in part in response to receiving the indication of the first TMSI, the TMSI component 830 may be configured as or otherwise support a means for receiving at least one additional response corresponding to each of the at least one additional registration request, each additional registration response of the at least one additional registration response including an indication of an additional TMSI corresponding to a set of POs for the UE that fail to satisfy the threshold timing value for the UE. In some examples, to support transmitting the registration request at least in part in response to receiving the indication of the first TMSI, the registration component 835 may be configured as or otherwise support a means for transmitting the registration request at least in part in response to receiving the indication of the first TMSI and the indication of the additional TMSI.

In some examples, the paging component 840 may be configured as or otherwise support a means for determining that the second set of POs for the UE fails to satisfy the threshold timing value. In some examples, the registration component 835 may be configured as or otherwise support a means for selectively transmitting one or more additional registration requests based on comparing a total number of transmitted registration requests to a threshold number of registration requests.

In some examples, the registration component 835 may be configured as or otherwise support a means for transmitting the one or more additional registration requests based on determining that the total number of transmitted registration requests is less than the threshold number of registration requests.

In some examples, the registration component 835 may be configured as or otherwise support a means for refraining from transmitting the one or more additional registration requests based on determining that the total number of transmitted registration requests is greater than or equal to the threshold number of registration requests. In some examples, the paging component 840 may be configured as or otherwise support a means for monitoring for the one or more paging messages from the base station according to the first set of POs based on the total number of transmitted registration requests being greater than or equal to the threshold number of registration requests. In some examples, the threshold number of registration requests is a quantity of one or more DRX cycles.

In some examples, the first TMSI includes a first short TMSI and the second TMSI includes a second short TMSI, the first short TMSI including an AMF set identifier, an AMF pointer, and a first fifth generation TMSI, and the second short TMSI including the AMF set identifier, the AMF pointer, and a second fifth generation TMSI.

In some cases, the subscription component, TMSI component, registration component, the paging component, or a combination thereof may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the subscription component, TMSI component, registration component, the paging component, or a combination thereof discussed herein.

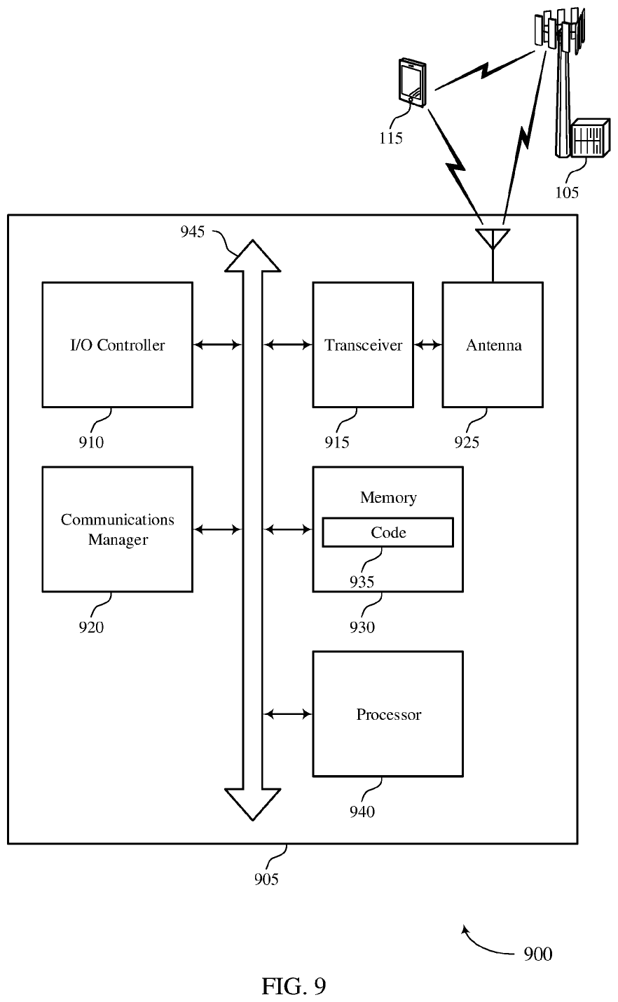

FIG. 9 shows a diagram of a system 900 including a device 905 that supports PO update using a registration request in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting PO update using a registration request). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for establishing a first wireless connection with a base station. The communications manager 920 may be configured as or otherwise support a means for receiving an indication of a first TMSI for the UE, the first TMSI corresponding to a first set of POs for the UE that fail to satisfy a threshold timing value for the UE. The communications manager 920 may be configured as or otherwise support a means for transmitting, to the base station, a registration request at least in part in response to receiving the indication of the first TMSI. The communications manager 920 may be configured as or otherwise support a means for receiving a response to the registration request that indicates a second TMSI for the UE. The communications manager 920 may be configured as or otherwise support a means for receiving one or more paging messages from the base station in a second set of POs that correspond to the second TMSI.

By including or configuring the communications manager 920 in accordance with examples as described herein, the device 905 may support techniques for a UE to transmit additional registration requests to a base station to update one or more POs to satisfy a threshold timing value, which may improve communication reliability, reduce latency, improve user experience related to reduced processing, reduce power consumption, cause more efficient utilization of communication resources, improve coordination between subscriptions, extend battery life, improve utilization of processing capability, and more.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of PO update using a registration request as described herein, or the processor 940 and the memory 930 may be otherwise configured to perform or support such operations.

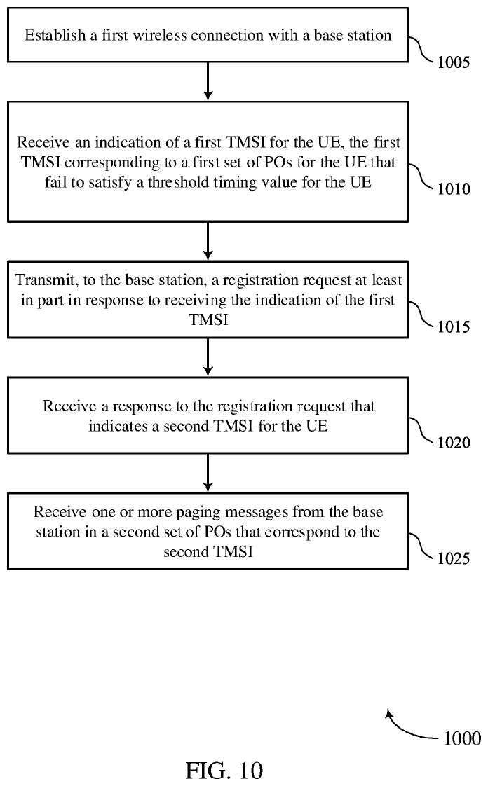

FIG. 10 shows a flowchart illustrating a method 1000 that supports PO update using a registration request in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include establishing a first wireless connection with a base station. The operations of 1005 may be performed in accordance with examples as disclosed herein. In some examples, aspects of the operations of 1005 may be performed by a subscription component 825 as described with reference to FIG. 8.

At 1010, the method may include receiving an indication of a first TMSI for the UE, the first TMSI corresponding to a first set of POs for the UE that fail to satisfy a threshold timing value for the UE. The operations of 1010 may be performed in accordance with examples as disclosed herein. In some examples, aspects of the operations of 1010 may be performed by an TMSI component 830 as described with reference to FIG. 8.

At 1015, the method may include transmitting, to the base station, a registration request at least in part in response to receiving the indication of the first TMSI. The operations of 1015 may be performed in accordance with examples as disclosed herein. In some examples, aspects of the operations of 1015 may be performed by a registration component 835 as described with reference to FIG. 8.

At 1020, the method may include receiving a response to the registration request that indicates a second TMSI for the UE. The operations of 1020 may be performed in accordance with examples as disclosed herein. In some examples, aspects of the operations of 1020 may be performed by an TMSI component 830 as described with reference to FIG. 8.

At 1025, the method may include receiving one or more paging messages from the base station in a second set of POs that correspond to the second TMSI. The operations of 1025 may be performed in accordance with examples as disclosed herein. In some examples, aspects of the operations of 1025 may be performed by a paging component 840 as described with reference to FIG. 8.

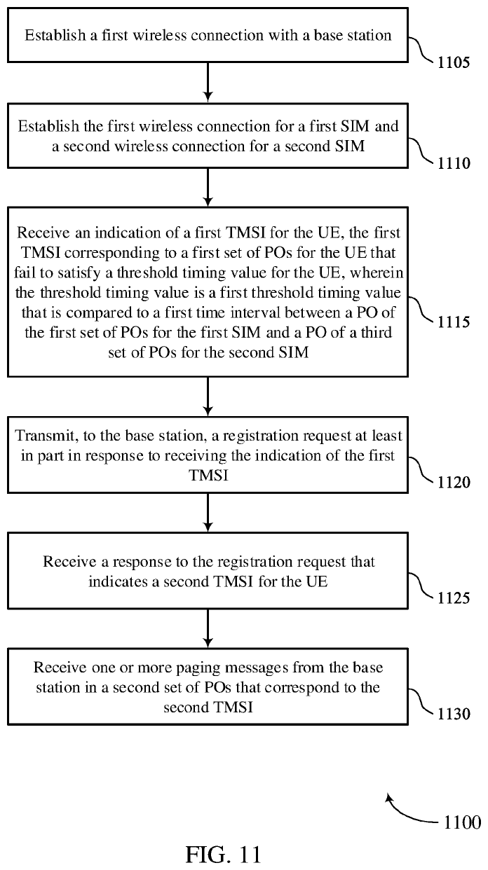

FIG. 11 shows a flowchart illustrating a method 1100 that supports PO update using a registration request in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include establishing a first wireless connection with a base station. The operations of 1105 may be performed in accordance with examples as disclosed herein. In some examples, aspects of the operations of 1105 may be performed by a subscription component 825 as described with reference to FIG. 8.

At 1110, the method may include establishing the first wireless connection for a first SIM and a second wireless connection for a second SIM. The operations of 1110 may be performed in accordance with examples as disclosed herein. In some examples, aspects of the operations of 1110 may be performed by a subscription component 825 as described with reference to FIG. 8.

At 1115, the method may include receiving an indication of a first TMSI for the UE, the first TMSI corresponding to a first set of POs for the UE that fail to satisfy a threshold timing value for the UE, where the threshold timing value is a first threshold timing value that is compared to a first time interval between a PO of the first set of POs for the first SIM and a PO of a third set of POs for the second SIM. The operations of 1115 may be performed in accordance with examples as disclosed herein. In some examples, aspects of the operations of 1115 may be performed by an TMSI component 830 as described with reference to FIG. 8.

At 1120, the method may include transmitting, to the base station, a registration request at least in part in response to receiving the indication of the first TMSI. The operations of 1120 may be performed in accordance with examples as disclosed herein. In some examples, aspects of the operations of 1120 may be performed by a registration component 835 as described with reference to FIG. 8.

At 1125, the method may include receiving a response to the registration request that indicates a second TMSI for the UE. The operations of 1125 may be performed in accordance with examples as disclosed herein. In some examples, aspects of the operations of 1125 may be performed by an TMSI component 830 as described with reference to FIG. 8.

At 1130, the method may include receiving one or more paging messages from the base station in a second set of POs that correspond to the second TMSI. The operations of 1130 may be performed in accordance with examples as disclosed herein. In some examples, aspects of the operations of 1130 may be performed by a paging component 840 as described with reference to FIG. 8.

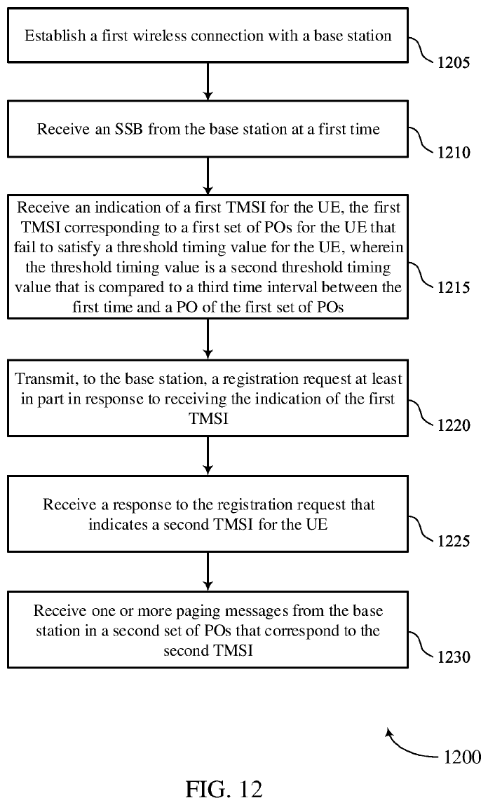

FIG. 12 shows a flowchart illustrating a method 1200 that supports PO update using a registration request in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include establishing a first wireless connection with a base station. The operations of 1205 may be performed in accordance with examples as disclosed herein. In some examples, aspects of the operations of 1205 may be performed by a subscription component 825 as described with reference to FIG. 8.

At 1210, the method may include receiving an SSB from the base station at a first time. The operations of 1210 may be performed in accordance with examples as disclosed herein. In some examples, aspects of the operations of 1210 may be performed by an SSB component 845 as described with reference to FIG. 8.

At 1215, the method may include receiving an indication of a first TMSI for the UE, the first TMSI corresponding to a first set of POs for the UE that fail to satisfy a threshold timing value for the UE, where the threshold timing value is a second threshold timing value that is compared to a third time interval between the first time and a PO of the first set of POs. The operations of 1215 may be performed in accordance with examples as disclosed herein. In some examples, aspects of the operations of 1215 may be performed by an TMSI component 830 as described with reference to FIG. 8.

At 1220, the method may include transmitting, to the base station, a registration request at least in part in response to receiving the indication of the first TMSI. The operations of 1220 may be performed in accordance with examples as disclosed herein. In some examples, aspects of the operations of 1220 may be performed by a registration component 835 as described with reference to FIG. 8.

At 1225, the method may include receiving a response to the registration request that indicates a second TMSI for the UE. The operations of 1225 may be performed in accordance with examples as disclosed herein. In some examples, aspects of the operations of 1225 may be performed by an TMSI component 830 as described with reference to FIG. 8.

At 1230, the method may include receiving one or more paging messages from the base station in a second set of POs that correspond to the second TMSI. The operations of 1230 may be performed in accordance with examples as disclosed herein. In some examples, aspects of the operations of 1230 may be performed by a paging component 840 as described with reference to FIG. 8.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a UE, comprising: establishing a first wireless connection with a base station; receiving an indication of a first temporary mobile subscription identifier for the UE, the first temporary mobile subscription identifier corresponding to a first set of paging occasions for the UE that fail to satisfy a threshold timing value for the UE; transmitting, to the base station, a registration request at least in part in response to receiving the indication of the first temporary mobile subscription identifier; receiving a response to the registration request that indicates a second temporary mobile subscription identifier for the UE; and receiving one or more paging messages from the base station in a second set of paging occasions that correspond to the second temporary mobile subscription identifier.

Aspect 2: The method of aspect 1, further comprising: establishing the first wireless connection for a first subscriber identity module and a second wireless connection for a second subscriber identity module, wherein the threshold timing value is a first threshold timing value that is compared to a first time interval between a paging occasion of the first set of paging occasions for the first subscriber identity module and a paging occasion of a third set of paging occasions for the second subscriber identity module.

Aspect 3: The method of aspect 2, wherein the first set of paging occasions fail to satisfy the first threshold timing value based at least in part on the paging occasion of the first set of paging occasions being less than or equal to a threshold time interval from the paging occasion of the third set of paging occasions; and the second set of paging occasions satisfy the first threshold timing value based at least in part on a paging occasion of the second set of paging occasions being greater than or equal to the threshold time interval from the paging occasion of the third set of paging occasions.

Aspect 4: The method of aspect 2, wherein the paging occasion of the first set of paging occasions fails to satisfy the first threshold timing value based at least in part on at least a portion of the paging occasion of the first set of paging occasions overlapping in time with at least a portion of the paging occasion of the third set of paging occasions.

Aspect 5: The method of any of aspects 2 through 4, further comprising: identifying a second time interval associated with the UE receiving and processing a synchronization signal block; and adjusting the first threshold timing value to be at least as long as the second time interval.

Aspect 6: The method of any of aspects 1 through 5, further comprising: receiving a synchronization signal block from the base station at a first time, wherein the threshold timing value is a second threshold timing value that is compared to a third time interval between the first time and a paging occasion of the first set of paging occasions.

Aspect 7: The method of aspect 6, wherein the paging occasion of the first set of paging occasions fail to satisfy the second threshold timing value based at least in part on the third time interval between the first time and the paging occasion of the first set of paging occasions being greater than or equal to the second threshold timing value.

Aspect 8: The method of any of aspects 1 through 7, wherein transmitting the registration request at least in part in response to receiving the indication of the first temporary mobile subscription identifier comprises: transmitting at least one additional registration request at least in part in response to the indication of the first temporary mobile subscription identifier; receiving at least one additional response corresponding to each of the at least one additional registration request, each additional registration response of the at least one additional registration response comprising an indication of an additional temporary mobile subscription identifier corresponding to a set of paging occasions for the UE that fail to satisfy the threshold timing value for the UE; and transmitting the registration request at least in part in response to receiving the indication of the first temporary mobile subscription identifier and the indication of the additional temporary mobile subscription identifier.

Aspect 9: The method of any of aspects 1 through 8, further comprising: determining that the second set of paging occasions for the UE fails to satisfy the threshold timing value; and selectively transmitting one or more additional registration requests based at least in part on comparing a total number of transmitted registration requests to a threshold number of registration requests.

Aspect 10: The method of aspect 9, further comprising: transmitting the one or more additional registration requests based at least in part on determining that the total number of transmitted registration requests is less than the threshold number of registration requests.

Aspect 11: The method of aspect 9, further comprising: refraining from transmitting the one or more additional registration requests based at least in part on determining that the total number of transmitted registration requests is greater than or equal to the threshold number of registration requests; and monitoring for the one or more paging messages from the base station according to the first set of paging occasions based at least in part on the total number of transmitted registration requests being greater than or equal to the threshold number of registration requests.

Aspect 12: The method of any of aspects 9 through 11, wherein the threshold number of registration requests is a quantity of one or more discontinuous reception cycles.

Aspect 13: The method of any of aspects 1 through 12, wherein the first temporary mobile subscription identifier comprises a first short temporary mobile subscription identifier and the second temporary mobile subscription identifier comprises a second short temporary mobile subscription identifier, the first short temporary mobile subscription identifier comprising an access and mobility management function (AMF) set identifier, an AMF pointer, and a first fifth generation temporary mobile subscription identifier, and the second short temporary mobile subscription identifier comprising the AMF set identifier, the AMF pointer, and a second fifth generation temporary mobile subscription identifier.

Aspect 14: An apparatus for wireless communications at a UE, comprising a processor; memory coupled with the processor; and instructions stored in the memory and executable by the processor to cause the apparatus to perform a method of any of aspects 1 through 13.

Aspect 15: An apparatus for wireless communications at a UE, comprising at least one means for performing a method of any of aspects 1 through 13.

Aspect 16: A non-transitory computer-readable medium storing code for wireless communications at a UE, the code comprising instructions executable by a processor to perform a method of any of aspects 1 through 13.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
establishing a first wireless connection with a base station;
receiving an indication of a first temporary mobile subscription identifier for the UE, the first temporary mobile subscription identifier corresponding to a first set of paging occasions for the UE that fail to satisfy a threshold timing value for the UE;
transmitting, to the base station, a registration request at least in part in response to receiving the indication of the first temporary mobile subscription identifier;
receiving a response to the registration request that indicates a second temporary mobile subscription identifier for the UE; and
receiving one or more paging messages from the base station in a second set of paging occasions that correspond to the second temporary mobile subscription identifier.

2. The method of claim 1, further comprising:
establishing the first wireless connection for a first subscriber identity module and a second wireless connection for a second subscriber identity module, wherein the threshold timing value is a first threshold timing value that is compared to a first time interval between a paging occasion of the first set of paging occasions for the first subscriber identity module and a paging occasion of a third set of paging occasions for the second subscriber identity module.

3. The method of claim 2, wherein:
the first set of paging occasions fail to satisfy the first threshold timing value based at least in part on the paging occasion of the first set of paging occasions being less than or equal to a threshold time interval from the paging occasion of the third set of paging occasions; and
the second set of paging occasions satisfy the first threshold timing value based at least in part on a paging occasion of the second set of paging occasions being greater than or equal to the threshold time interval from the paging occasion of the third set of paging occasions.

4. The method of claim 2, wherein the paging occasion of the first set of paging occasions fails to satisfy the first threshold timing value based at least in part on at least a portion of the paging occasion of the first set of paging occasions overlapping in time with at least a portion of the paging occasion of the third set of paging occasions.

5. The method of claim 2, further comprising:
identifying a second time interval associated with the UE receiving and processing a synchronization signal block; and
adjusting the first threshold timing value to be at least as long as the second time interval.

6. The method of claim 1, further comprising:
receiving a synchronization signal block from the base station at a first time, wherein the threshold timing value is a second threshold timing value that is compared to a third time interval between the first time and a paging occasion of the first set of paging occasions.

7. The method of claim 6, wherein the paging occasion of the first set of paging occasions fail to satisfy the second threshold timing value based at least in part on the third time interval between the first time and the paging occasion of the first set of paging occasions being greater than or equal to the second threshold timing value.

8. The method of claim 1, wherein transmitting the registration request at least in part in response to receiving the indication of the first temporary mobile subscription identifier comprises:
transmitting at least one additional registration request at least in part in response to the indication of the first temporary mobile subscription identifier;
receiving at least one additional response corresponding to each of the at least one additional registration request, each additional registration response of the at least one additional registration response comprising an indication of an additional temporary mobile subscription identifier corresponding to a set of paging occasions for the UE that fail to satisfy the threshold timing value for the UE; and
transmitting the registration request at least in part in response to receiving the indication of the first temporary mobile subscription identifier and the indication of the additional temporary mobile subscription identifier.

9. The method of claim 1, further comprising:
determining that the second set of paging occasions for the UE fails to satisfy the threshold timing value; and
selectively transmitting one or more additional registration requests based at least in part on comparing a total number of transmitted registration requests to a threshold number of registration requests.

10. The method of claim 9, further comprising:
transmitting the one or more additional registration requests based at least in part on determining that the total number of transmitted registration requests is less than the threshold number of registration requests.

11. The method of claim 9, further comprising:
refraining from transmitting the one or more additional registration requests based at least in part on determining that the total number of transmitted registration requests is greater than or equal to the threshold number of registration requests; and
monitoring for the one or more paging messages from the base station according to the first set of paging occasions based at least in part on the total number of transmitted registration requests being greater than or equal to the threshold number of registration requests.

12. The method of claim 9, wherein the threshold number of registration requests is a quantity of one or more discontinuous reception cycles.

13. The method of claim 1, wherein the first temporary mobile subscription identifier comprises a first short temporary mobile subscription identifier and the second temporary mobile subscription identifier comprises a second short temporary mobile subscription identifier, the first short temporary mobile subscription identifier comprising an access and mobility management function (AMF) set identifier, an AMF pointer, and a first fifth generation temporary mobile subscription identifier, and the second short temporary mobile subscription identifier comprising the AMF set identifier, the AMF pointer, and a second fifth generation temporary mobile subscription identifier.

14. An apparatus for wireless communications at a user equipment (UE), comprising:
a processor;
memory coupled with the processor; and
instructions stored in the memory and executable by the processor to cause the apparatus to:
establish a first wireless connection with a base station;
receive an indication of a first temporary mobile subscription identifier for the UE, the first temporary mobile subscription identifier corresponding to a first set of paging occasions for the UE that fail to satisfy a threshold timing value for the UE;
transmit, to the base station, a registration request at least in part in response to receiving the indication of the first temporary mobile subscription identifier;
receive a response to the registration request that indicates a second temporary mobile subscription identifier for the UE; and
receive one or more paging messages from the base station in a second set of paging occasions that correspond to the second temporary mobile subscription identifier.

15. The apparatus of claim 14, wherein the instructions are further executable by the processor to cause the apparatus to:
establish the first wireless connection for a first subscriber identity module and a second wireless connection for a second subscriber identity module, wherein the threshold timing value is a first threshold timing value that is compared to a first time interval between a paging occasion of the first set of paging occasions for the first subscriber identity module and a paging occasion of a third set of paging occasions for the second subscriber identity module.

16. The apparatus of claim 15, wherein:
the first set of paging occasions fail to satisfy the first threshold timing value based at least in part on the paging occasion of the first set of paging occasions being less than or equal to a threshold time interval from the paging occasion of the third set of paging occasions; and
the second set of paging occasions satisfy the first threshold timing value based at least in part on a paging occasion of the second set of paging occasions being greater than or equal to the threshold time interval from the paging occasion of the third set of paging occasions.

17. The apparatus of claim 15, wherein the paging occasion of the first set of paging occasions fails to satisfy the first threshold timing value based at least in part on at least a portion of the paging occasion of the first set of paging occasions overlapping in time with at least a portion of the paging occasion of the third set of paging occasions.

18. The apparatus of claim 15, wherein the instructions are further executable by the processor to cause the apparatus to:
identify a second time interval associated with the UE receiving and processing a synchronization signal block; and
adjust the first threshold timing value to be at least as long as the second time interval.

19. The apparatus of claim 14, wherein the instructions are further executable by the processor to cause the apparatus to:
receive a synchronization signal block from the base station at a first time, wherein the threshold timing value is a second threshold timing value that is compared to a third time interval between the first time and a paging occasion of the first set of paging occasions.

20. The apparatus of claim 19, wherein the paging occasion of the first set of paging occasions fail to satisfy the second threshold timing value based at least in part on the third time interval between the first time and the paging occasion of the first set of paging occasions being greater than or equal to the second threshold timing value.

21. The apparatus of claim 14, wherein the instructions are further executable by the processor to transmit the registration request at least in part in response to receiving the indication of the first temporary mobile subscription identifier by being executable by the processor to:
transmit at least one additional registration request at least in part in response to the indication of the first temporary mobile subscription identifier;
receive at least one additional response corresponding to each of the at least one additional registration request, each additional registration response of the at least one additional registration response comprising an indication of an additional temporary mobile subscription identifier corresponding to a set of paging occasions for the UE that fail to satisfy the threshold timing value for the UE; and
transmit the registration request at least in part in response to receiving the indication of the first temporary mobile subscription identifier and the indication of the additional temporary mobile subscription identifier.

22. The apparatus of claim 14, wherein the instructions are further executable by the processor to cause the apparatus to:
determine that the second set of paging occasions for the UE fails to satisfy the threshold timing value; and
selectively transmit one or more additional registration requests based at least in part on comparing a total number of transmitted registration requests to a threshold number of registration requests.

23. The apparatus of claim 22, wherein the instructions are further executable by the processor to cause the apparatus to:
transmit the one or more additional registration requests based at least in part on determining that the total number of transmitted registration requests is less than the threshold number of registration requests.

24. The apparatus of claim 22, wherein the instructions are further executable by the processor to cause the apparatus to:
refrain from transmitting the one or more additional registration requests based at least in part on determining that the total number of transmitted registration requests is greater than or equal to the threshold number of registration requests; and
monitor for the one or more paging messages from the base station according to the first set of paging occasions based at least in part on the total number of transmitted registration requests being greater than or equal to the threshold number of registration requests.

25. The apparatus of claim 22, wherein the threshold number of registration requests is a quantity of one or more discontinuous reception cycles.

26. The apparatus of claim 14, wherein the first temporary mobile subscription identifier comprises a first short temporary mobile subscription identifier and the second temporary mobile subscription identifier comprises a second short temporary mobile subscription identifier, the first short temporary mobile subscription identifier comprising an access and mobility management function (AMF) set identifier, an AMF pointer, and a first fifth generation temporary mobile subscription identifier, and the second short temporary mobile subscription identifier comprising the AMF set identifier, the AMF pointer, and a second fifth generation temporary mobile subscription identifier.

27. An apparatus for wireless communications at a user equipment (UE), comprising:
means for establishing a first wireless connection with a base station;
means for receiving an indication of a first temporary mobile subscription identifier for the UE, the first temporary mobile subscription identifier corresponding to a first set of paging occasions for the UE that fail to satisfy a threshold timing value for the UE;
means for transmitting, to the base station, a registration request at least in part in response to receiving the indication of the first temporary mobile subscription identifier;
means for receiving a response to the registration request that indicates a second temporary mobile subscription identifier for the UE; and
means for receiving one or more paging messages from the base station in a second set of paging occasions that correspond to the second temporary mobile subscription identifier.

28. The apparatus of claim 27, further comprising:
means for establishing the first wireless connection for a first subscriber identity module and a second wireless connection for a second subscriber identity module, wherein the threshold timing value is a first threshold timing value that is compared to a first time interval between a paging occasion of the first set of paging occasions for the first subscriber identity module and a paging occasion of a third set of paging occasions for the second subscriber identity module.

29. The apparatus of claim 27, further comprising:
means for receiving a synchronization signal block from the base station at a first time, wherein the threshold timing value is a second threshold timing value that is compared to a third time interval between the first time and a paging occasion of the first set of paging occasions.

30. A non-transitory computer readable medium storing code for wireless communication, the code comprising instructions executable by a processor to:
establish a first wireless connection with a base station;
receive an indication of a first temporary mobile subscription identifier for the UE, the first temporary mobile subscription identifier corresponding to a first set of paging occasions for the UE that fail to satisfy a threshold timing value for the UE;
transmit, to the base station, a registration request at least in part in response to receiving the indication of the first temporary mobile subscription identifier;
receive a response to the registration request that indicates a second temporary mobile subscription identifier for the UE; and
receive one or more paging messages from the base station in a second set of paging occasions that correspond to the second temporary mobile subscription identifier.
